(19) United States
(12) Patent Application Publication
(10) Pub. No.: US 2026/0316183 A1
(43) Pub. Date: Oct. 15, 2026

(54) LASER PROCESSING DEVICE AND LASER PROCESSING METHOD

(71) Applicant: MITSUBISHI HEAVY INDUSTRIES, LTD., Tokyo (JP)

(72) Inventors: Ryuichi Narita, Tokyo (JP); Saneyuki Goya, Tokyo (JP); Jiro Yoneda, Tokyo (JP); Shigetoshi Shiotani, Tokyo (JP); Shin Asano, Tokyo (JP)

(73) Assignee: MITSUBISHI HEAVY INDUSTRIES, LTD., Tokyo (JP)

(21) Appl. No.: 19/100,962

(22) PCT Filed: Jul. 10, 2023
(86) PCT No.: PCT/JP2023/025379

§ 371 Date: Feb. 4, 2025

(30) Foreign Application Priority Data
Oct. 6, 2022 (JP) 2022-161323

(51) Int. Cl. B23K 26/08; B23K 26/142; B23K 37/02

(52) U.S. Cl. CPC B23K 26/0869; B23K 26/142; B23K 37/0211

(57) ABSTRACT

A laser machining unit includes: a first moving part; a second moving part movably supported by the first moving part; and a laser irradiation unit movably supported by the second moving part. A first maximum movement distance of the second moving part by the first moving part is longer than a second maximum movement distance of the laser irradiation unit by the second moving part. The first moving part is configured to move the second moving part in both a first direction and a second direction orthogonal to the first direction. The second moving part is configured to move the laser irradiation unit in both the first direction and the second direction. The first maximum movement distance is longer than the second maximum movement distance in both the first direction and the second direction.

### TECHNICAL FIELD

The present disclosure relates to a laser machining unit and a laser processing method that are suitable for processing a composite material.

### BACKGROUND ART

Fiber reinforced plastics (FRP) are lightweight and have high strength, and thus are used for, for example, an airframe of an aircraft. As representative examples of FRP, glass fiber reinforced plastics (GFRP) and carbon fiber reinforced plastics (CFRP) are known.

Irradiation with a laser beam is performed for processing such as cutting a member consisting of fiber reinforced plastics. For example, PTL 1 discloses a laser machining unit for a composite material that can achieve high speed and high accuracy. PTL 1 provides two laser oscillation means of primary laser oscillation means that supplies a primary laser beam and secondary laser oscillation means that supplies a secondary laser beam. During irradiation with the primary laser beam, the primary laser beam is emitted while moving within a width of a cutting main portion under a high-speed condition. In addition, during irradiation with the secondary laser beam, a part irradiated with the primary laser beam is irradiated with the secondary laser beam.

### CITATION LIST

### Patent Literature

[PTL 1] Japanese Unexamined Patent Application Publication No. 2015-157312

### SUMMARY OF INVENTION

### Technical Problem

A laser machining unit of PTL 1 includes a work station on which a workpiece processed by laser beam is placed. In the laser machining unit of PTL 1, positions of the primary laser oscillation means and the secondary laser oscillation means are fixed, and in a case where the workpiece is processed, the workpiece is moved to a relative position with respect to laser oscillation means of the workpiece by operating the work station.

A method of operating and processing the work station is applicable to a case where a workpiece is small, but is not suitable for a large workpiece. For example, a workpiece related to an aircraft may also have a total length of several tens of meters. Meanwhile, in addition to a large dimension of the work station itself, which mounts the workpiece, a space for operating the work station is also required. In addition, in a large work station, accuracy and speed of movement are inferior.

From the above, an object of the present disclosure is to provide a laser machining unit and a laser processing method that can quickly perform processing with high accuracy, even in a case where the workpiece has a large dimension.

### Solution to Problem

A laser machining unit according to the present disclosure includes a first moving part, a second moving part movably supported by the first moving part, and a laser irradiation unit movably supported by the second moving part.

A first maximum movement distance of the second moving part by the first moving part is longer than a second maximum movement distance of the laser irradiation unit by the second moving part.

The first moving part is configured to move the second moving part in both a first direction and a second direction orthogonal to the first direction, the second moving part is configured to move the laser irradiation unit in both the first direction and the second direction, and the first maximum movement distance is longer than the second maximum movement distance in both the first direction and the second direction.

While the laser irradiation unit emits a laser beam to perform processing of a workpiece, a movement of the second moving part by the first moving part is stopped, but a movement of the laser irradiation unit by the second moving part is continued.

In a laser processing method according to the present disclosure, along a predetermined processing path and by emitting a laser beam from a laser head, processing of a processing region in which the processing path is divided into a plurality of sections is sequentially performed.

In the laser processing method, a processing step of processing the preceding processing region while the laser head moves and a region movement step of moving the laser head for processing the subsequent processing region after the processing of the preceding processing region is completed are repeated.

### Advantageous Effects of Invention

With the laser machining unit according to the present disclosure, the first moving part having a long maximum movement distance is provided. Therefore, even in a case where a workpiece having a large dimension is provided, the entire region thereof can be processed without missing any part. In addition, with the laser machining unit according to the present disclosure, the second moving part having a short maximum movement distance supports the laser head. Therefore, it is possible to quickly perform processing with high accuracy.

With the laser processing method according to the present disclosure, it is possible to quickly perform processing with high accuracy in the processing step. Therefore, even in a case where a workpiece having a large dimension is provided, it is possible to perform processing of the entire region thereof without missing any part by repeatedly performing the region movement step.

### BRIEF DESCRIPTION OF DRAWINGS

FIG. 1 is a front view (FV) and a side view (SV) showing a laser machining unit according to an embodiment of the present disclosure.

FIG. 2 is a front view (FV) and a side view (SV) showing an operation of a second moving part 30.

FIG. 3 is a view showing an example of a processing procedure by the laser machining unit according to the embodiment.

FIG. 4 is a view showing an example of the processing procedure by the laser machining unit according to the embodiment, following FIG. 3.

FIG. 5 is a flowchart showing an example of the processing procedure by the laser machining unit according to the embodiment.

FIG. 6 is a front view showing another example of the operation of the second moving part 30.

FIG. 7 is a front view showing another example of the operation of the second moving part 30.

### DESCRIPTION OF EMBODIMENTS

Hereinafter, a laser machining unit 1 according to an embodiment will be described with reference to the accompanying drawings. All of the following descriptions are examples in the present disclosure.

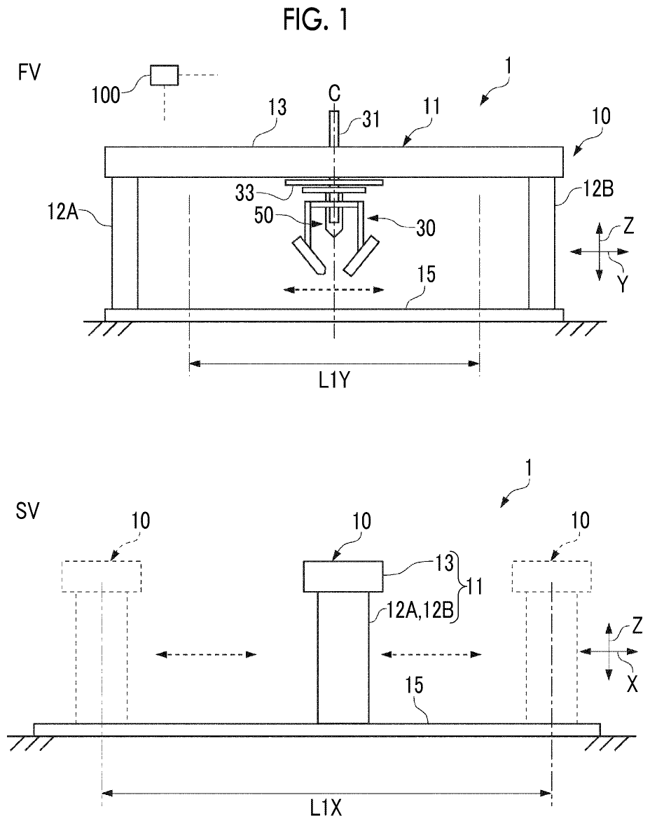

### [Overall Configuration of Laser Machining Unit 1: Refer to FIG. 1]

As shown in FIG. 1, the laser machining unit 1 includes a first moving part 10, a second moving part 30 supported by the first moving part 10, and a laser irradiation unit 50 supported by the second moving part 30. In the laser machining unit 1, in a case where processing a workpiece W having a large dimension, the second moving part 30 is operated in a case where processing each of processing regions (CA1 to CAn) divided into a plurality of sections, and the first moving part 10 is operated in a case of transition from the preceding processing region (CAn) to be processed to a subsequent processing region (CAn+1). Since a maximum movement distance of the second moving part 30 in a case where laser processing is performed is shortened, it is possible to quickly perform processing with high accuracy. In addition, since the first moving part 10 has a long maximum movement distance, the entire region of the workpiece W can be processed without moving the workpiece W even in a case where the workpiece W has a large dimension. Hereinafter, the first moving part 10, the second moving part 30, and the laser irradiation unit 50 will be described in detail in this order. In the laser machining unit 1, as shown in FIG. 1, a longitudinal direction X, a width direction Y, and a height direction Z are defined. In addition, in the present disclosure, the maximum movement distance refers to a distance at which movement derived from mechanical specifications can be performed. In addition, in a case where simply referred to as a movement distance, the movement distance is a distance that is actually moved for laser processing and falls within a range of the maximum movement distance.

### [First Moving Part 10: Refer to FIG. 1]

The first moving part 10 has a maximum movement distance corresponding to processing of the workpiece W having a large dimension of, for example, a total length of 20 to 30 m. However, in a process of processing the workpiece W, the first moving part 10 does not move the entire maximum movement distance at once, but moves only by a distance required to move the processing regions (CAn→CAn+1) before and after each other. In a case where movement distances in the processing regions (CA1 to CAn) are summed, the sum may reach maximum movement distance. The first moving part 10 can move a moving frame 11 in the longitudinal direction X and the width direction Y.

The first moving part 10 includes the moving frame 11 having a gate shape in a case where viewed from a front surface and a base 15 on which a position for supporting the moving frame 11 is fixed.

The moving frame 11 includes a pair of column legs 12A and 12B provided at an interval in the width direction Y, and a beam material 13 supported at both ends by upper end portions of the column legs 12A and 12B.

For example, each of the column legs 12A and 12B is provided with a roller that travels a pair of rails corresponding to the column legs 12A and 12B provided on the base 15 by rotation on a lower end thereof. In addition, for example, each of the column legs 12A and 12B is provided with a movable element of a linear motor corresponding to a linear stator of a pair of linear motors corresponding to the column legs 12A and 12B provided on the base 15 at the lower end thereof.

The beam material 13 supports the second moving part 30. Therefore, the second moving part 30 is moved in the longitudinal direction X and the width direction Y as the first moving part 10 moves.

The moving frame 11 can reciprocate within a range of a maximum movement distance L1X in the longitudinal direction X. This reciprocating movement is realized by known means such as a rotary roller or a linear motor provided in the column legs 12A and 12B described above along a linear trajectory. In the moving frame 11, a portion that supports the laser irradiation unit 50 of the beam material 13 can reciprocate in a range of a maximum movement distance L1Y (<L1X) in the width direction Y This reciprocating movement is also realized by known means. The maximum movement distances L1X and L1Y exceed a dimension of the workpiece W in the longitudinal direction X and a dimension of the workpiece W in the width direction Y, the workpiece being mounted on the base 15, and the first moving part 10 has a maximum movement distance sufficient for processing the entire region of the workpiece W. However, the moving frame 11 is stopped without moving while the workpiece W is processed by being irradiated with the laser beam.

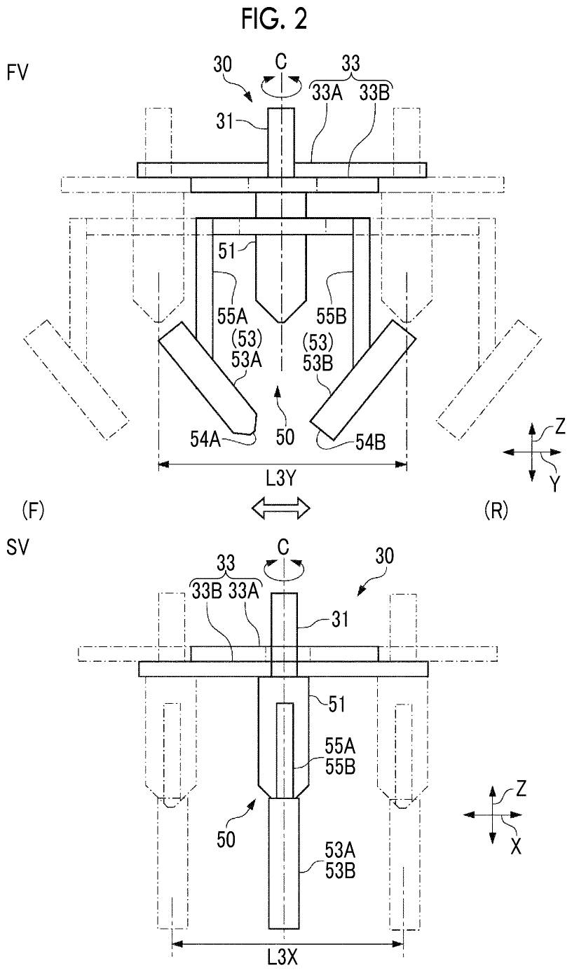

### [Second Moving Part 30: Refer to FIGS. 1 and 2]

The second moving part 30 is movable in the longitudinal direction X and the width direction Y while being supported by the beam material 13 of the first moving part 10. The second moving part 30 moves while the workpiece W is in the middle of processing by irradiation with the laser beam.

As shown in FIGS. 1 and 2, the second moving part 30 includes a main shaft 31 that supports a laser head 51 and a two-dimensional stage 33 that supports the main shaft 31. The main shaft 31 is rotatable around an axis C by appropriate means, and the laser head 51 supported by the main shaft 31 is also rotatable in forward and reverse directions around the axis C by appropriate means. The two-dimensional stage 33 includes, for example, a first moving body 33A that can reciprocate in the longitudinal direction X and a second moving body 33B that can reciprocate in the width direction Y.

The main shaft 31 can be made to be a robot having six degrees of freedom typically in a vertical multi-joint type, not only rotating around the axis C.

As an example, each of the first moving body 33A and the second moving body 33B is movable by a linear motor. The movable element is provided on a side of the first moving body 33A, and the stator with respect to the movable element is provided on a side of the second moving body 33B. In addition, the movable element is provided on the side of the second moving body 33B, and the stator with respect to the movable element is provided on the side of the first moving body 33A. In this way, the first moving body 33A and the second moving body 33B can move relative to each other.

While the workpiece W is in the middle of processing the workpiece W, one or both of the first moving body 33A and the second moving body 33B are moved. As shown in a front view (FV) and a side view (SV) of FIG. 2, the first moving body 33A is movable in a range of a distance L3X in the longitudinal direction X, and the second moving body 33B is movable in a range of a distance L3Y in the width direction Y.

The first moving part 10 has a longer maximum movement distance than that of the second moving part 30, and conversely, the second moving part 30 has a shorter maximum movement distance than that of the first moving part 10, such that the distances L1X, L1Y, L3X, and L3Y have the following relationship. As an example, the maximum movement distance of the first moving part 10 also reaches several tens of +meters, for example, 30 m, but the maximum movement distance of the second moving part 30 is sufficient to be several meters, for example, about 2 m.

$$Distance L 1 X > Distance L 3 X$$

$$Distance L 1 Y > Distance L 3 Y$$

### [Laser Irradiation Unit 50: Refer FIGS. 1 and 2]

Next, the laser irradiation unit 50 includes the laser head 51 that emits a laser beam for processing the workpiece W, and a collection machine 53 that collects flying debris generated during processing with the laser beam.

A type of the laser head 51 is not limited as long as the workpiece W can be processed. However, the dimension of the workpiece W set as a processing target by the laser machining unit 1 is large, and a thickness of the workpiece W to be cut as an example of processing is also large. Therefore, it is preferable to apply a single mode fiber laser featuring high output as the laser head 51.

In a case where the workpiece W is subjected to laser processing, dust and smoke, which are referred to as fumes and spatter, are generated from a processed portion. In the present disclosure, the dust and smoke generated from the processed portion are collectively referred to as flying debris. Since the flying debris is a hindrance to the irradiation of the workpiece W with the laser beam, it is desirable that the flying debris is recovered from the processed portion. Therefore, as a preferable element of the laser irradiation unit 50, the collection machine 53 is provided for scavenging. Here, scavenging means performing both supply air and exhaust air to collect flying debris. That is, the collection machine 53 includes, as an example, an air supply nozzle 53A that supplies a scavenging gas such as air or an inert gas to the processed portion, and an exhaust duct 53B that discharges the scavenging gas containing the flying debris from the processed portion. As a preferred form, the laser machining unit 1 continues to supply the scavenging gas from the air supply nozzle 53A and continues to discharge the scavenging gas including the flying debris from the exhaust duct 53B while processing the workpiece W. Although a form in which both the air supply nozzle 53A and the exhaust duct 53B are provided is preferable, only one of the air supply nozzle 53A and the exhaust duct 53B can also be used as long as the flying debris can be removed from the processed portion.

Each of the air supply nozzle 53A and the exhaust duct 53B of the collection machine 53 is fixed to the laser head 51 through a support arm 55A and a support arm 55B that configure a support body, and is rotated together with the laser head 51 as the main shaft 31 rotates. An air supply port 54A of the air supply nozzle 53A supported by the support arm 55A and an exhaust port 54B of the exhaust duct 53B supported by the support arm 55B are provided to face each other in a region where the workpiece W is likely to be irradiated with the laser beam. While the workpiece W is being processed, the air supply nozzle 53A and the exhaust duct 53B move together with the laser head 51. At this time, in consideration of an efficiency of scavenging, it is desirable to place the air supply nozzle 53A on a moving front side (F) and to place the exhaust duct 53B on the opposite rear side (R) as shown in FIG. 2. In a case where the air supply nozzle 53A is placed on the moving front side (F), a flow of the scavenging gas follows a flow of a relative atmosphere due to the movement, so that the scavenging gas can be introduced into the exhaust duct 53B with almost no reception of resistance in an opposite orientation. Before and after this situation, it is assumed that the second moving part 30 moves leftward in the drawing of a white arrow in FIG. 2. In a case where the second moving part 30 moves to rightward in the drawing of the white arrow in FIG. 2, the front side (F) is replaced with the rear side (R), and the rear side (R) is replaced with the front side (F).

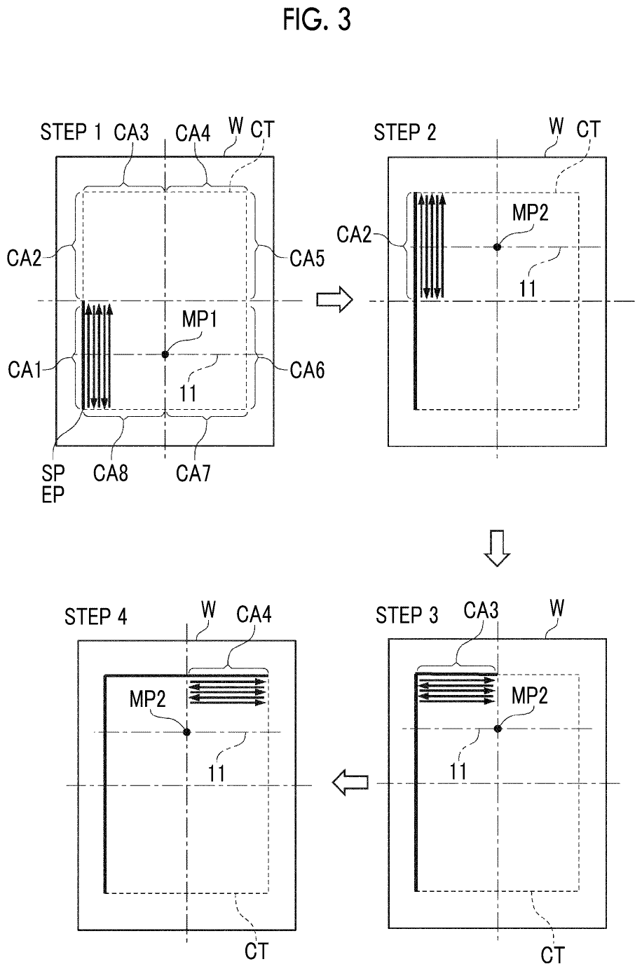

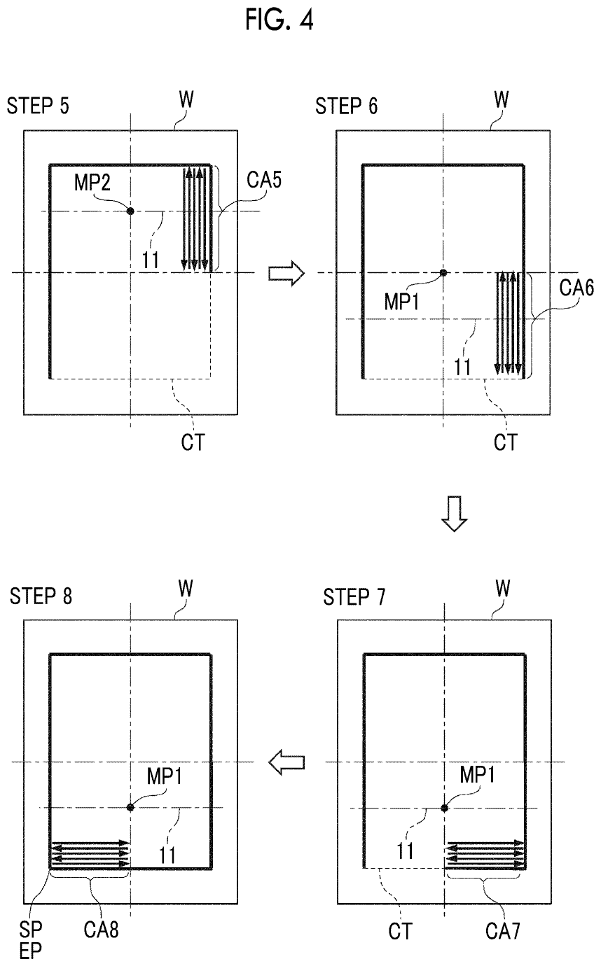

### [Processing Procedure: Refer to FIGS. 3 and 4]

Next, a procedure for processing the workpiece W using the laser machining unit 1 will be described with reference to FIGS. 3 and 4. The workpiece W used for description is made of a composite material having a rectangular shape in a plan view as an example. Processing for cutting the workpiece W is performed along a rectangular processing path CT indicated by a broken line of the workpiece W. The workpiece W has a thickness that cannot be cut by irradiating the workpiece W with the laser beam emitted from the laser head 51 only once pass, for example, a thickness of 20 mm, in addition to the dimension in a plan view. FIGS. 3 and 4 are prepared only for describing the processing procedure, and the dimension of the workpiece W and a movement distance of the laser head 51 shown in FIGS. 3 and 4 are optional. In FIGS. 3 and 4, the processing procedure proceeds in the order of STEP 1, STEP 2, and so on. In addition, in the processing procedure, the processing path CT is divided into eight first regions CA1 to CA8, and cutting of a first region CA1, cutting of a second region CA2, . . . , and cutting of an eighth region CA8 are executed in order.

### [FIG. 3 STEP 1 Cutting of First Region CA1]

First, the first region CA1 is cut (FIG. 3 STEP 1).

In a case where the first region CA1 is cut, the moving frame 11 of the first moving part 10 is stopped at a position corresponding to the first region CA1, as an example, an intermediate point MP1 corresponding to the first region CA1. On the other hand, the second moving part 30 reciprocates while cutting the workpiece W. This reciprocating movement indicates that the laser head 51 also reciprocates. In FIG. 3, a solid line arrow indicates that the reciprocating movement is performed, and in STEP 1, an upward arrow indicates an outward path of one pass, and a downward arrow indicates a return path of one pass. These arrows indicate the movement itself, but do not indicate a position to be moved to. In FIG. 3, a thick solid line drawn on the processing path CT indicates that the first region CA1 of the workpiece W is cut by the reciprocating movement of the laser head 51. The cutting of the first region CA1 starts from the start point SP, and ends by moving along the outward path after the cutting reciprocates only twice along the outward path toward the second region CA2 and the return path opposite to the outward path, as an example. That is, the reciprocating movement is performed by operating the two-dimensional stage 33 of the second moving part 30 while the laser head 51 moves for five passes.

While the first region CA1 is cut, an orientation of the collection machine 53 is determined such that the air supply nozzle 53A and the exhaust duct 53B are along the processing path CT. Then, as described above, the air supply nozzle 53A is placed on the front side and the exhaust duct 53B is placed on the rear side. However, since the laser head 51 reciprocates, the main shaft 31 is rotated by 180 degrees to change disposition of the air supply nozzle 53A and the exhaust duct 53B in accordance with the movement of the laser head 51 being reversed. This also applies to the subsequent second region CA2.

### [FIG. 3 STEP 2 Cutting of Second Region CA2]

In a case where the cutting of the first region CA1 is completed, the process transitions to the cutting of the second region CA2 (FIG. 3 STEP 2). With this transition, the moving frame 11 of the first moving part 10 has moved to a position corresponding to the second region CA2, and has stopped at an intermediate point MP2 corresponding to the second region CA2 as an example. During this period, the second moving part 30 and the laser irradiation unit 50 stop operating. In the second region CA2 as well, the cutting is completed by reciprocating the second region CA2 only 2.5 times, that is, only 5 passes, by operating the two-dimensional stage 33 of the second moving part 30 while the laser head 51 irradiates the second region CA2 of the processing path CT with the laser beam.

### [FIG. 3 STEP 3 Cutting of Third Region CA3]

In a case where the cutting of the second region CA2 is completed, the process transitions to the cutting of the third region CA3 (FIG. 3 STEP 3). An orientation of the third region CA3 is orthogonal to orientations of the preceding first region CA1 and second region CA2. Therefore, in the laser irradiation unit 50, particularly orientations of the air supply nozzle 53A and the exhaust duct 53B of the collection machine 53 can be changed by rotating the main shaft 31 by only 90 degrees. At this time, the air supply nozzle 53A is placed on the front side, and the exhaust duct 53B is placed on the rear side.

In the third region CA3 as well, the cutting is completed by reciprocating the third region CA3 only 2.5 times by operating the two-dimensional stage 33 of the second moving part 30 while the laser head 51 irradiates the third region CA3 of the processing path CT with the laser beam.

### [FIG. 3 STEP 4 Cutting of Fourth Region CA4]

In a case where the cutting of the third region CA3 is completed, the process transitions to cutting of a fourth region CA4. With this transition, the moving frame 11 of the first moving part 10 has moved to a position corresponding to the fourth region CA4, and has stopped at an intermediate point MP2 corresponding to the second region CA2 as an example. During this period, the second moving part 30 and the laser irradiation unit 50 stop operating. In the fourth region CA4 as well, the cutting is completed by reciprocating the fourth region CA4 only 2.5 times by operating the two-dimensional stage 33 of the second moving part 30 while the laser head 51 irradiates the fourth region CA4 of the processing path CT with the laser beam.

### [FIG. 4 STEPS 5 to 8]

In the above description, a distance of ½ of the processing path CT is cut. However, thereafter, as shown in FIG. 4, the entire region of the processing path CT can be cut by performing the same procedure as before.

In the above-described embodiment, as an example, distances of regions CA1, CA2, CA5, and CA6 are the same, and distances of regions CA3, CA4, CA7, and CA8 are also the same. However, in the present disclosure, a distance of the processing region that divides the processing path CT is optional according to a shape including the dimension of the workpiece W.

In addition, in the above-described embodiment, an example in which the thickness of the workpiece W is constant is shown. However, in the present disclosure, the workpiece W having a thickness that changes in the processing region can be also set as a processing target. In this case, the number of reciprocating movements of the laser head 51 is adjusted such that the number of reciprocating movements is increased in a thick processing region and the number of reciprocating movements is decreased in a thin processing region.

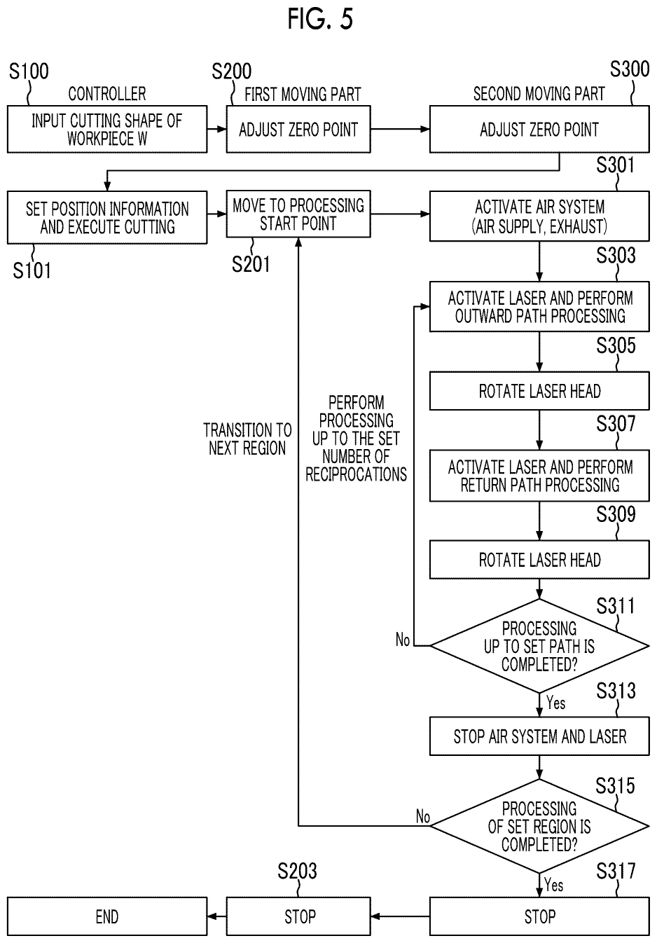

### [Control Procedure: FIG. 5]

Next, an example of a control procedure in a case where the workpiece W is cut using the laser machining unit 1 will be described with reference to FIG. 5. The laser machining unit 1 includes a controller 100 that controls the operations of the first moving part 10, the second moving part 30, and the laser irradiation unit 50. The following control procedure is performed by the controller 100. The following description follows a cutting procedure of the workpiece W described with reference to FIGS. 3 and 4.

The control procedure starts with inputting a shape (including dimensions), in which the workpiece W is cut, into the controller 100 (FIG. 5 S100). The following control is performed based on the input cutting shape. The processing path CT shown in FIGS. 3 and 4 is defined by the input cutting shape.

The controller 100 adjusts a zero point of the first moving part 10 and adjusts a zero point of the second moving part 30, based on the defined processing path CT (FIG. 5 S200, S300). The first moving part 10 and the second moving part 30 perform movement necessary for cutting processing according to an instruction from the controller 100 with the zero point as a reference.

After the zero point adjustment of the first moving part 10 and the second moving part 30 is performed, the controller 100 divides the processing path CT into the first region CA1 to the eighth region CA8 and sets position information required for the first moving part 10 and the second moving part 30 to move (FIG. 5 S101). The position information is two-dimensional (xn, yn) information in a case of the flat workpiece W and is three-dimensional (xn, yn, zn) information in a case of the undulating workpiece W. The position information includes the start point SP where the cutting processing starts and an end point EP where the cutting ends. In a processing example shown in FIGS. 3 and 4, the start point SP and the end point EP coincide with each other. However, the start point SP and the end point EP may be different from each other. In a case where the position information is set, the controller 100 drives the first moving part 10, the second moving part 30, and the laser irradiation unit 50 to perform cutting. Specifically, the process is as follows.

First, the controller 100 instructs a driving source of the first moving part 10 to move the first moving part 10 to a position corresponding to the start point SP (FIG. 5 S201). In a case where the first moving part 10 has moved to the start point SP, an operation of the second moving part 30 and the laser irradiation unit 50 is instructed, and the actual cutting processing is performed in the following procedure.

Before actual processing with the laser beam, the controller 100 activates an air system including a blower, a suction machine, or the like such that the flying debris can be scavenged (FIG. 5 S301). Subsequently, the controller 100 activates the laser beam source to emit a laser beam from the laser head 51 and operates the second moving part 30. As a result, while the laser head 51 is moved along the outward path of the first pass in the first region CA1, the outward path is processed (FIG. 5 S303). In a case where the laser head 51 has moved and processed to the end point of the outward path, the operation of the second moving part 30 and the emission of the laser beam from the laser head 51 are temporarily stopped, and the laser head 51 is rotated by 180 degrees with the air supply nozzle 53A and the exhaust duct 53B in the meantime (FIG. 5 S305). Preparation for the cutting processing of the return path of the first pass is completed by the rotation of the laser head 51. In this way, the controller 100 activates the laser beam source to emit a laser beam from the laser head 51 and operates the second moving part 30. As a result, while the laser head 51 is moved along the return path of the first pass in the first region CA1, the return path is processed (FIG. 5 S307).

In a case where the laser head 51 has moved and processed to the end point of the return path, the operation of the second moving part 30 and the emission of the laser beam from the laser head 51 are temporarily stopped, and the laser head 51 is rotated by 180 degrees with the air supply nozzle 53A and the exhaust duct 53B in the meantime (FIG. 5 S309). In this way, preparation for cutting processing of an outward path of a next pass is completed. However, here, instead of immediately starting the cutting processing of the outward path of the next pass, it is determined whether or not processing of all of a plurality of paths that are preset has been completed (FIG. 5 S311).

In a case where the processing of all the paths has not been completed (FIG. 5 S311 No), processing of the outward path of the next pass is started, and the above procedure is repeated (FIG. 5 S303 to S309).

In a case where the processing of all the paths is completed (FIG. 5 S311 Yes), the controller 100 stops the air system and laser (FIG. 5 S313). Then, the controller determines whether or not the processing from the first region CA1 to the eighth region CA8 is completed in a case where all the processing regions set in advance, that is, FIGS. 3 and 4 are shown as an example (FIG. 5 S315). In a case where the processing of all the set regions is completed (FIG. 5 S315 Yes), the movements of the second moving part 30 and the first moving part 10 are stopped, and the processing of the workpiece W is completed (S317, S203). In a case where the processing of all the set regions has not been completed (FIG. 5 S315 No), the processing procedure described above is repeated after the second moving part 30 and the first moving part 10 are moved to the next region, for example, a processing start point of the second region CA2 (FIG. 5 S303 to S309).

### [Effect of Laser Machining Unit 1]

With the laser machining unit 1, the first moving part 10 having a long maximum movement distance is provided, so that even the workpiece W having a large dimension can be processed in the entire region. In addition, with the laser machining unit according to the present disclosure, the second moving part 30 having a short maximum movement distance supports the laser head 51. Therefore, it is possible to quickly perform processing with high accuracy.

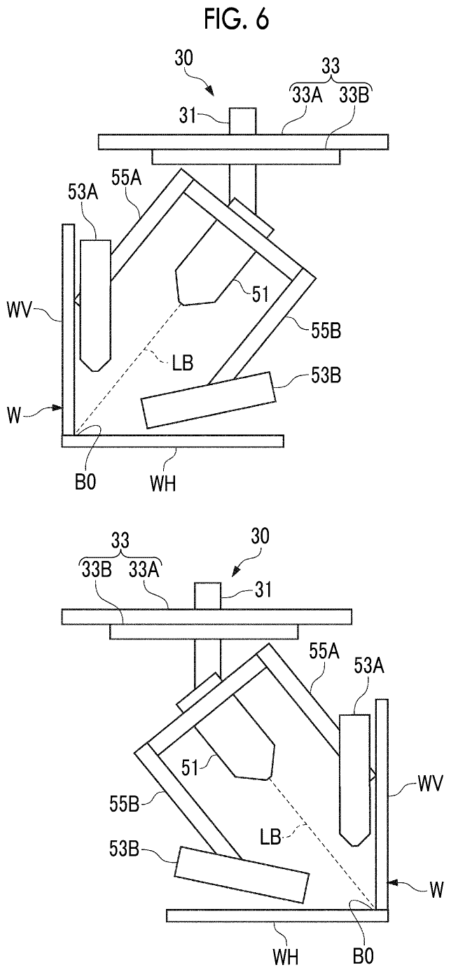

### [Posture of Laser Head 51: FIG. 6]

In the embodiment described above, the workpiece W subjected to the cutting processing is along a horizontal direction, so that a posture of the laser head 51 is along a vertical direction. However, the cutting processing can be performed by setting the posture of the laser head 51 to be inclined with respect to the vertical direction. The posture of the laser head 51 can be changed because the main shaft 31 has a multi-joint. For example, FIG. 6 shows two examples of processing the workpiece W having an L-shaped cross section having a vertical portion WV along the vertical direction and a horizontal portion WH along the horizontal direction. The two examples differ in whether the vertical portion WV is on a right or left side of a paper surface. Here, as an example, a boundary BO between the vertical portion WV and the horizontal portion WH is subjected to cutting processing, so that the laser head 51 is inclined such that a laser beam LB is emitted to the boundary BO. For the air supply nozzle 53A and the exhaust duct 53B, the air supply nozzle 53A is disposed above the exhaust duct 53B on the boundary BO to be cut such that the scavenging gas is blown downward from above. By performing disposition in this way, scavenging efficiency does not decrease.

Here, an example of cutting the boundary BO between the vertical portion WV and the horizontal portion WH has been shown. However, for example, in a case where the laser head 51 is disposed along the horizontal direction, the vertical portion WV can also be subjected to cutting processing.

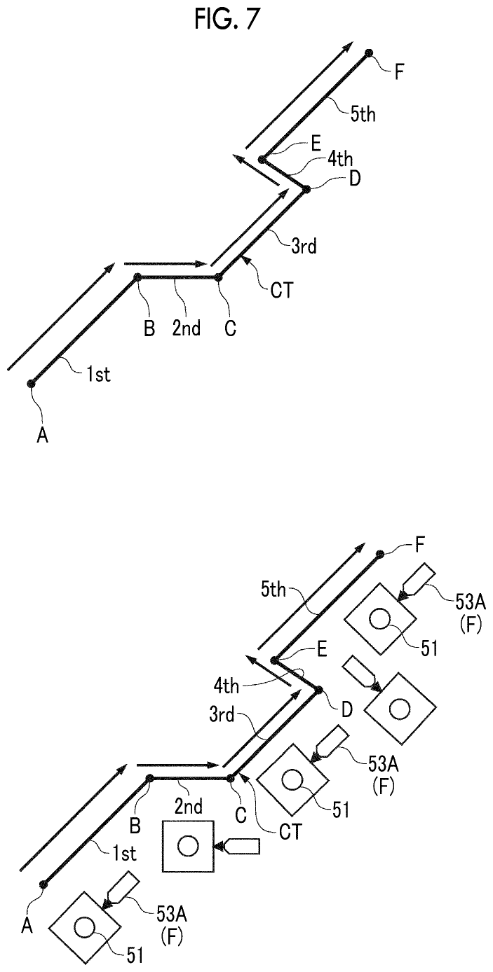

### [Orientation of Collection Machine 53: FIG. 7]

Next, the orientation of the collection machine 53 in a case where the laser head 51 moves and performs cutting processing while an orientation of the laser head 51 is changed will be described with reference to FIG. 7. The orientation in which the laser head 51 moves is indicated by a solid line arrow.

In a case where the workpiece W is cut along the processing path CT shown in FIG. 7, it is necessary to change a moving orientation of the laser head 51 at a point A, a point B, a point C, a point D, and a point E after departure from the point A. The orientation change can be realized by operating the first moving body 33A and the second moving body 33B of the two-dimensional stage 33 in combination.

Here, in order to efficiently perform the scavenging, it is preferable that the air supply nozzle 53A and the exhaust duct 53B are along each of sections of the processing path CT, and in addition, the air supply nozzle 53A supplies air from the front side (F) with respect to the laser head 51. As described above, the air supply nozzle 53A and the exhaust duct 53B face each other with the laser head 51 interposed therebetween, and are fixed to the laser head 51. Therefore, as shown in a lower part of FIG. 7, the air supply nozzle 53A and the exhaust duct 53B can be adjusted to be parallel to the processing path CT by rotating the laser head 51. In a case where disposition is performed as described above, the scavenging gas can be blown with maximum utilization of force with which the scavenging gas is blown, compared to a case where the scavenging gas is blown obliquely. Therefore, high scavenging efficiency can be obtained. In addition, a description of the exhaust duct 53B is not shown in FIG. 7.

### APPENDIX

### Appendix 1

A laser machining unit (1) includes a first moving part (10), a second moving part (30) movably supported by the first moving part (10), and a laser irradiation unit (50) movably supported by the second moving part (30). First maximum movement distances (L1X, L1Y) of the second moving part (30) by the first moving part (10) are longer than second maximum movement distances (L3X, L3Y) of the laser irradiation unit (50) by the second moving part (30).

In the laser machining unit (1), the first moving part (10) is configured to move the second moving part (30) in both a first direction (X) and a second direction (Y) orthogonal to the first direction, the second moving part (30) is configured to move the laser irradiation unit (50) in both the first direction (X) and the second direction (Y).

The first maximum movement distances (L1X, L1Y) are longer than the second maximum movement distances (L3X, L3Y) in both the first direction (X) and the second direction (Y).

With the laser machining unit (1) including this configuration, both the first moving part (10) and the second moving part (30) are movable in both the first direction (X) and the second direction (Y) orthogonal to the first direction (X), and thus processing corresponding to a complicated processing path (CT) can be performed.

While the laser irradiation unit (50) emits a laser beam to perform processing of a workpiece (W), a movement of the second moving part (30) by the first moving part (10) is stopped, but a movement of the laser irradiation unit (50) by the second moving part (30) is continued.

According to the laser machining unit (1) including this configuration, in a case where actual processing is performed, only the second moving part (30) is moved. Therefore, compared to a case where the first moving part (10) is also moved, control with respect to the movement can be easily performed.

### Appendix 2

In Appendix 1, it is preferable that the movement of the laser irradiation unit (50) by the second moving part (30) is performed along a predetermined processing path (CT), and processing is sequentially performed for each of a plurality of regions (CA1 to CA8) into which the processing path (CT) is divided, while the laser irradiation unit (50) is moved by the second moving part (30).

Since the maximum movement distance of the laser irradiation unit (50) by the second moving part (30) is short, the processing path (CT) is divided into the plurality of regions (CA1 to CA8) such that the movement distance is equal to or less than the short maximum movement distance.

### Appendix 3

In Appendix 2, it is preferable that for each of the plurality of regions (CA1 to CA8), processing is performed while the laser irradiation unit (50) reciprocates.

The laser irradiation unit (50) is reciprocated, so that even a thick workpiece W can be cut.

### Appendix 4

In Appendix 2 or 3, it is preferable that in a case where a transition to processing of the subsequent region (CA2) is performed after the processing of the preceding region (CA1) is completed, the second moving part (30) is moved by the first moving part (10) from a position corresponding to the preceding region (CA1) to a position corresponding to the subsequent region (CA2).

In consideration of a case where a distance from a position corresponding to the preceding region (CA1) to a position corresponding to the subsequent region (CA2) is long and a case where the movement is performed to a position corresponding to the further subsequent region (CA3), it is preferable that the movement between regions is performed by the first moving part having a long maximum movement distance.

### Appendix 5

In any one of Appendixes 1 to 4, it is preferable that the laser irradiation unit (50) includes a laser head (51) that emits a laser beam, and a collection machine (53) for flying debris generated by irradiation of the workpiece (W) with the laser beam.

By including the collection machine (53) for flying debris, it is possible to stably obtain processing performance by the irradiation with the laser beam.

### Appendix 6

In Appendix 5, the preferable collection machine (53) includes an air supply nozzle (53A) that supplies a scavenging gas, and an exhaust duct (53B) disposed to face the air supply nozzle (53A) with the laser head (51) interposed between the exhaust duct (53B) and the air supply nozzle (53A). The air supply nozzle (53A) is disposed on a front side (F) on which the laser head (51) moves, and the exhaust duct (53B) is disposed on a rear side (R).

Since a scavenging gas flow is along a relative atmosphere flow due to the movement by disposing the air supply nozzle (53A) on the front side with respect to the exhaust duct (53B), the scavenging gas can enter the exhaust duct (53B) with almost no resistance in an opposite orientation. That is, an efficiency of recovery by scavenging is high.

### Appendix 7

In Appendix 6, in the preferable air supply nozzle (53A) and exhaust duct (53B), in a case where processing is performed while moving upward in a vertical direction along a predetermined processing path (CT) along the vertical direction, the air supply nozzle (53A) is disposed above the exhaust duct (53B).

By disposing and processing in this way, the scavenging gas can be blown downward in the vertical direction along the gravity, so that scavenging efficiency can be prevented from falling.

### Appendix 8

In Appendix 6, the preferable air supply nozzle (53A) and the exhaust duct (53B) are rotatably provided about the laser head (51) to be disposed parallel to a processing path (CT) in which an orientation is changed.

By disposing and processing in this way, a force with which the scavenging gas is blown can be maximally utilized, so that high scavenging efficiency can be obtained.

### Appendix 9

The present disclosure provides a method in which along a predetermined processing path (CT) and by emitting a laser beam from a laser head (51), processing of processing regions (CA1 to CA8) in which the processing path (CT) is divided into a plurality of sections is sequentially performed.

In this processing method, a processing step of processing the preceding region (CA1) while the laser head (51) moves and a region movement step of moving the laser head (51) for processing the subsequent region (CA2) after the processing of the preceding region (CA1) is completed are repeated.

With the processing method according to the present disclosure, it is possible to quickly perform processing with high accuracy in the processing step. Therefore, even in a case where a workpiece (W) having a large dimension is provided, it is possible to perform processing of the entire region thereof by repeatedly performing the region movement step.

In addition to the above, it is possible to select the configurations described in the embodiment described above or to change the configurations to other configurations as appropriate.

### REFERENCE SIGNS LIST

1: laser machining unit
10: first moving part
11: moving frame
12A, 12B: column leg
13: beam material
15: base
30: second moving part
31: main shaft
33: two-dimensional stage
33A: first moving body
33B: second moving body
50: laser irradiation unit
51: laser head
53: collection machine
53A: air supply nozzle
53B: exhaust duct
54A: air supply port
54B: exhaust port
55A: support arm
55B: support arm
100: controller
CT: processing path
SP: start point
EP: end point
L1X, L1Y: maximum movement distance
L3X, L3Y: maximum movement distance
LB: laser beam
MP1, MP2: intermediate point
W: workpiece
WH: horizontal portion
WV: vertical portion
X: longitudinal direction
Y: width direction
Z: height direction

1. A laser machining unit comprising:
a first moving part;
a second moving part movably supported by the first moving part; and
a laser irradiation unit movably supported by the second moving part, wherein
a first maximum movement distance of the second moving part by the first moving part is longer than a second maximum movement distance of the laser irradiation unit by the second moving part,
the first moving part is configured to move the second moving part in both a first direction and a second direction orthogonal to the first direction,
the second moving part is configured to move the laser irradiation unit in both the first direction and the second direction,
the first maximum movement distance is longer than the second maximum movement distance in both the first direction and the second direction, and
while the laser irradiation unit emits a laser beam to perform processing of a workpiece, a movement of the second moving part by the first moving part is stopped, but a movement of the laser irradiation unit by the second moving part is continued.

2. The laser machining unit according to claim 1, wherein
the movement of the laser irradiation unit by the second moving part is performed along a predetermined processing path, and
processing is sequentially performed for each of a plurality of processing regions into which the processing path is divided, while the laser irradiation unit is moved by the second moving part.

3. The laser machining unit according to claim 2, wherein for each of the plurality of processing regions, processing is performed while the laser irradiation unit reciprocates.

4. The laser machining unit according to claim 3, wherein in a case where a transition to processing of a subsequent processing region is performed after the processing of a preceding processing region is completed, the second moving part is moved by the first moving part from a position corresponding to the preceding processing region to a position corresponding to the subsequent processing region.

5. The laser machining unit according to claim 1, wherein
the laser irradiation unit includes
a laser head that emits a laser beam, and
a collection machine for flying debris generated by irradiation of the workpiece with the laser beam.

6. The laser machining unit according to claim 5, wherein
the collection machine includes
an air supply nozzle that supplies a scavenging gas, and
an exhaust duct disposed to face the air supply nozzle with the laser head interposed between the exhaust duct and the air supply nozzle,
the air supply nozzle is disposed on a front side on which the laser head moves, and
the exhaust duct is disposed on a rear side.

7. The laser machining unit according to claim 6, wherein in the air supply nozzle and the exhaust duct, in a case where processing is performed while moving upward in a vertical direction along a predetermined processing path along the vertical direction, the air supply nozzle is disposed above the exhaust duct.

8. The laser machining unit according to claim 6, wherein the air supply nozzle and the exhaust duct are rotatably provided about the laser head to be disposed parallel to a processing path in which a predetermined orientation is changed.

9. A laser processing method in which along a predetermined processing path and by emitting a laser beam from a laser head, processing of processing regions in which the processing path is divided into a plurality of sections is sequentially performed, the laser processing method comprising:
a processing step of processing a preceding processing region while the laser head moves; and
a region movement step of moving the laser head for processing a subsequent processing region after the processing of the preceding processing region is completed, wherein
the processing step and the region movement step are repeated.
